(19) United States
(12) Patent Application Publication
(10) Pub. No.: US 2015/0084871 A1
(43) Pub. Date: Mar. 26, 2015

(54) CUSTOMIZED DISPLAY AND FUNCTION FOR KEYS ON A KEYBOARD

(71) Applicants: Mark D. Yarvis, Portland, OR (US); Ayeshwarya B. Mahajan, Bangalore (IN); Christopher J. Lord, Portland, OR (US); Ramesh Pendakur, Gaston, OR (US)

(72) Inventors: Mark D. Yarvis, Portland, OR (US); Ayeshwarya B. Mahajan, Bangalore (IN); Christopher J. Lord, Portland, OR (US); Ramesh Pendakur, Gaston, OR (US)

(21) Appl. No.: 14/498,891

(22) Filed: Sep. 26, 2014

(30) Foreign Application Priority Data
Sep. 26, 2013 (IN) 4363/CHE/2013

(51) Int. Cl. G06F 3/023; G06F 3/0488

(52) U.S. Cl. CPC G06F 3/0238; G06F 3/04886
USPC 345/172

(57) ABSTRACT

An electronic device is described herein. The electronic device includes a keyboard and a plurality of keys arranged on the keyboard. The plurality of keys may include dynamically customized keys based on usage. The display and function of the customized keys may be enabled through the use of platform components and cloud services on the keyboard. The customized keys may include generic, customer-specific, or dynamically updated images.

### CROSS-REFERENCE TO RELATED APPLICATION

This application claims the benefit of the filing date of an India Provisional Application No. 4363/CHE/2013, filed Sep. 26, 2013, the contents of which are incorporated herein by reference.

### TECHNICAL FIELD

The present disclosure generally relates to customized displays and customer-specific functions for keys on a keyboard.

### BACKGROUND ART

Manufacturers of many consumer electronic devices, including TVs, DVDs, and DVRs, and mobile devices are currently bundling direct access to services of third-party providers into the platforms of such devices. A device manufacturer may implement a button on a remote or an icon on a mobile device so that an end-user may directly access a specific service from a third-party service provider. For example, an end-user of the remote can conveniently access a preferred service at the push of a button, e.g. selecting a button for an on-demand streaming media provider to gain direct access to a preferred movie selection. Additionally, instead of a button, an end-user of a mobile device may select a dynamic application icon, or a “live title,” to activate a preferred application. The live tile is dynamic in the sense that it can display real-time summary or content information, e.g. displaying the number of new email messages in an end-user's inbox.

However, such conventional techniques are not integrated within a personal computing (PC) space. A lack of access to the services of third-party providers via a personal computing experience presents a barrier between the end-users and the service providers.

### BRIEF DESCRIPTION OF THE DRAWINGS

FIG. 1(A) is an illustration of a keyboard with a specific customized key mapped to services from a third-party service provider.

FIG. 1(B) is an illustration of a keyboard with a user-specific opportunities key that include dynamic content from a third-party service provider.

FIG. 1(C) is an illustration of a keyboard with a key leased or sold as real-estate on a keyboard to a third-party service provider.

FIG. 2 is a block diagram of an architecture for securely controlling displays and functions of a customized key on a keyboard.

FIG. 3 is an illustration of a signed image for display on a customized key.

FIG. 4 is a block diagram of an architecture for selecting a customized key.

FIG. 5 is a flow diagram of an activity flow of a Trusted Keyboard Manager (TKM).

FIG. 6 is a block diagram of a computing device that utilizes a keyboard with dynamically customized keys.

FIG. 7 is a block diagram of a tangible, non-transitory computer-readable medium.

FIG. 8 is a process flow diagram of a method for displaying a signed image for a customized key.

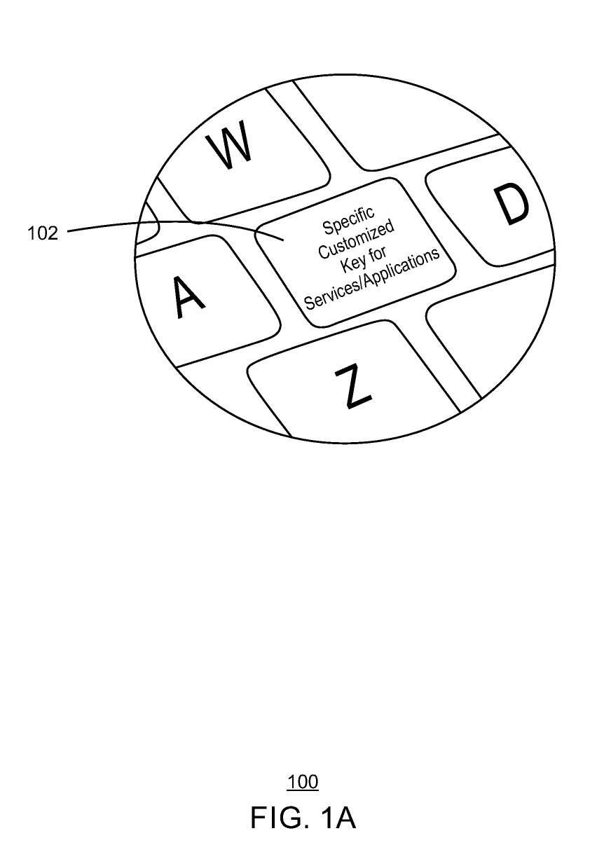

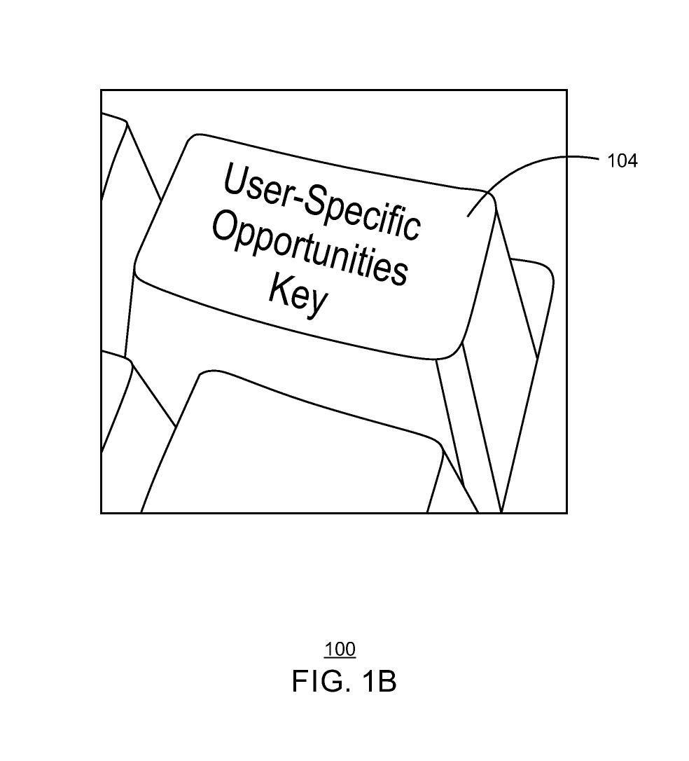

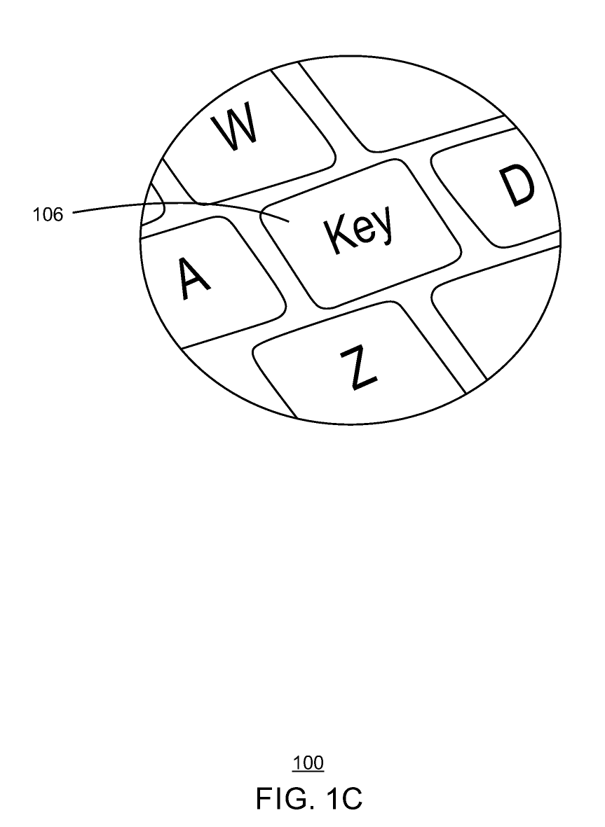

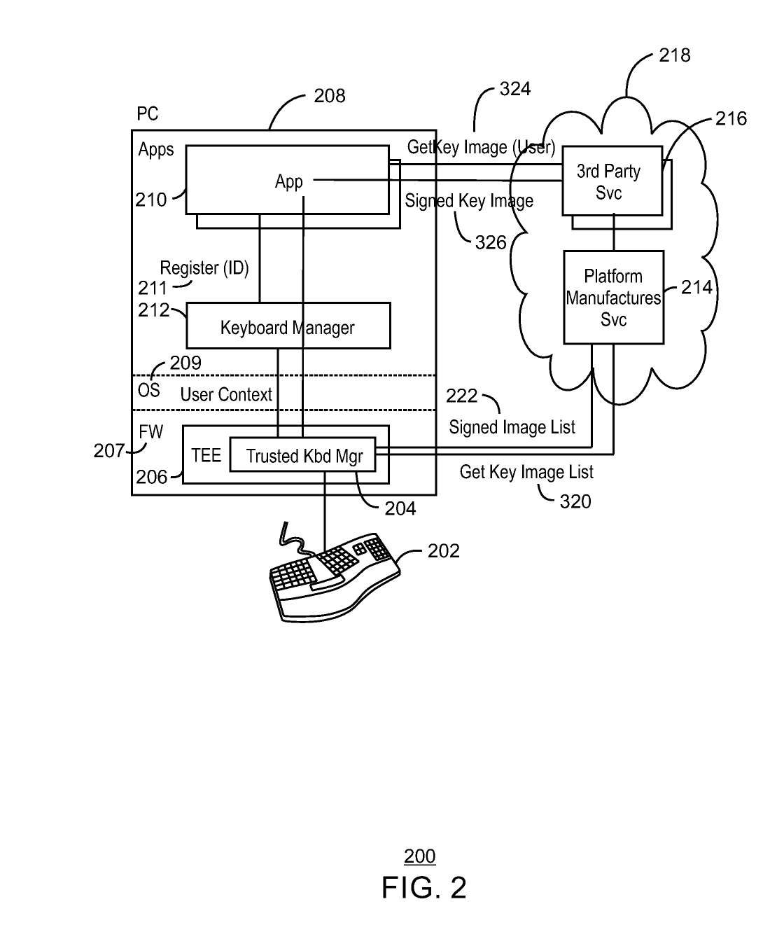

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The present disclosure is generally related to customized displays and customer-specific functions for keys on a keyboard. In particular, the present techniques relate to applying to a personal computing (PC) space both business models for consumer electronics to deliver branded buttons on devices and a notion of dynamic content from an application on a key or live tile. In some embodiments, the keyboard may be a physical keyboard with customizable keys or a virtual keyboard with customizable keys. In some embodiments, only verified signed images may be displayed on the customizable keys of the keyboard. In some embodiments, the press of a customized key may display combinations of static content, customer-specific content, and live content to an end-user.

As described above, known implementation for access to a service-provider directly from a device are mainly limited to consumer electronic devices and mobile devices. Embodiments of the subject innovation relate to facilitating access to a service or an opportunity within a PC space through the use of keys on a keyboard. According to the subject innovation, the images of generic services, customer-specific services, and dynamically updated applications may be displayed on a key, where the key would be mapped to a specific service or application when chosen by an end-user.

FIG. 1(A) is an illustration of a keyboard 100 with a specific customized key for services 102 mapped to a service or an application offered by a third-party service provider. In an embodiment, a device manufacturer may provide a key on a keyboard dedicated to a particular service provider. As shown in FIG. 1(A), the keyboard 100, located in a PC space, may include a specific customized key for services 102 that when pressed may connect an end-user directly to an array of services or applications offered by a third-party service provider. For example, a user may install a specific application on a PC where the keyboard 100 includes a key related to that specific application. As a result, the user may access that specific application by pressing the specific customized key for services 102, without having to directly access a website associated with that specific application. In some embodiments, the specific customized key for services 102 may display a business-specific image that may be delivered in the PC space by default or through the purchase of the PC device.

FIG. 1(B) is an illustration of a keyboard 100 with a user-specific opportunities key 104 to access content or applications from a third-party service provider. In an embodiment, a device manufacturer may provide a key on a keyboard dedicated to a particular interactive application and customized according to a user account or specific user context (e.g., an advertisement driven by known user interests, a count of items available in the user's inbox, notification of a shipped package). As shown in FIG. 1(B), the keyboard 100, located in a PC space, may include a user-specific opportunities key 104 that when pressed may allow an end-user to activate an interactive application, previously installed on the PC, in order to display specific real-time data from a third-party service provider. The user-specific opportunities key 104 may be related to a user's account, including the email account of an online shopping retailer, social media outlet, among others. For example, the user may press the user-specific opportunities key 104 where an email related to a current shipping order may be displayed. In some embodiments, the user-specific opportunities key 104 may display a business-specific image that may be delivered in the PC space based on current interactive applications installed on the PC space.

FIG. 1(C) is an illustration of a keyboard 100 with a key 106 leased or sold as real-estate on the keyboard to a third-party service provider. As shown in FIG. 1(C), a PC space includes the key 106, which may be leased or sold to a particular service provider who wishes to advertise their service, business, or product. For example, companies that provide on-demand Internet streaming media, online social networking, or online shopping, could lease or buy keyboard space in the form of the key 106 to advertise their name, product, or services. Any purchaser of the key 106 may be considered as an authorized partner. Accordingly, content provided by the authorized partner may be initially authorized and accepted by the various platforms of the device manufacturer and thereafter, displayed on the keyboard 100. Once pressed, the key 106 may deliver a combination of static content and customer-specific content.

In each case, the keys 102, 104, 106 may represent a dynamically customized key based on its particular intended usage. For example, each of the keys 102, 104, 106 may display static content, customer-specific content, third-party content, social-media content, online provider content, and online merchant content, among other interactive forms of content. In some aspects, each of the keys 102, 104, 106 may include live data, such as “Your order has now shipped,” “You have two messages in your inbox,” and “You have two offers available.”

FIG. 2 is a block diagram of the architecture 200 for the display of an image on a keycap on a keyboard. Various text and words, e.g., custom key images, may be display on the keycaps of a physical keyboard. As illustrated in FIG. 2, the architecture 200 may provide techniques to configure the keyboard 202 for the actual display of the custom key images. The keyboard 202 may be controlled by a Trusted Keyboard Manager (TKM) 204 that is running in a Trusted Execution Environment (TEE) platform 206. In embodiments, the TKM 204 and the TEE platform 206 are a portion of firmware 207. An operating system 209 may manage the system hardware and software resources, including the keyboard 202.

The TKM 204 may be primarily responsible for displaying a custom key image on the keyboard 202. On start-up of a PC device 208, the TKM 204 may have cached a set of generic images, e.g., runtime configurable display images, for display on the keycap of the keyboard 202. Thereafter, the TKM 204 may periodically consult with a platform manufacturer to obtain a list of additional images to display, including auto-complete recommendations or visible passwords. In embodiments, the TKM 204 may consult with cloud services 218 such as a platform manufacturer cloud service 214 or a third party cloud service 216 to obtain the list of additional keys to display.

On startup or during execution of an application 210 belonging to partner service providers, the application 210 can consult with its own service provider to obtain a signed image for a custom key. The application can then register itself (as illustrated at reference number 211) with the Keyboard Manager 212 running in the Operating System 209 or at the application layer and deliver the signed key image to the TKM 204. Thus, during execution of an application 210, the application 210 may deliver the generic custom key image to the TKM 204 for display. The TKM 204 may validate each custom key image before it is displayed by determining its validity and eligibility for display on the keycaps. As illustrated in FIG. 2, the keyboard manager 212 may interface with the keyboard 202 to display the generic custom key images. In the case of a virtual keyboard, the keyboard manager 212 may overlay the custom key images on top of the virtual keyboard of an operating system and may intercept a touch event corresponding to the custom keycaps.

In embodiments, the TKM 204 can automatically request or “get” a key image list from the cloud services 218 as illustrated at reference number 220. A signed image list may be sent to the TKM 204 from the cloud services 218 as illustrated by reference number 222. Similarly, a user can request or “get” a key image from the cloud services 218 as illustrated at reference number 224. A signed key image may be sent to the app 210 from the cloud services 218 as illustrated by reference number 226.

It is to be understood that the block diagram 200 of FIG. 2 is not intended to indicate that the architecture is to include all of the components shown in FIG. 2 in every case. Further, any number of additional components can be included within the block diagram 200, depending on the details of the specific implementation.

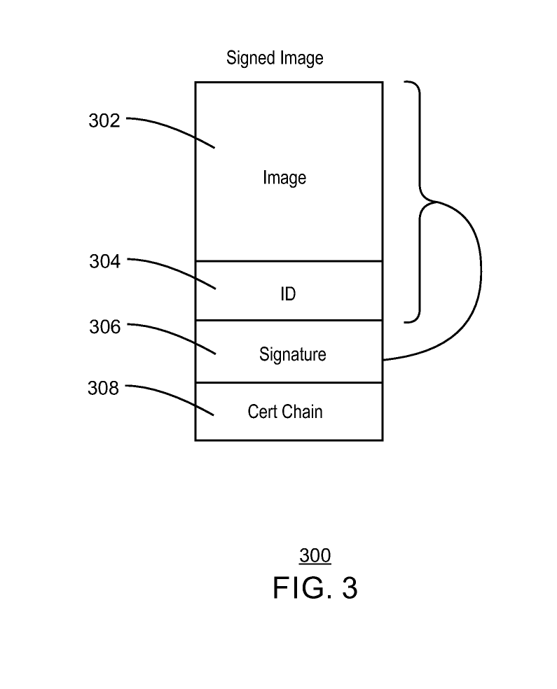

FIG. 3 is an illustration of a signed image 300 for display on a customized key. The customized keys may only display images generated and submitted by partners authorized to display on the keyboard. In operation, an authorized partner may deliver an image for display on the keyboard by delivering a signed image structure 300 to a device. As shown in FIG. 3, the signed image 300 may include an image to display 302, an assigned ID 304, a signature 306 generated using an assigned private key, and a public key certificate (cert) chain 308 of the authorized partner. A trusted keyboard manager (TKM) may then verify the signed image 300 by verifying the root of the cert chain 308, verifying each link on the cert chain 308, and validating that the signature 306 was generated by the owner of the private key associated with the last cert in the cert chain 308. If verification is met, the authorized partners may be given a unique identifier, a public/private key pair, and a public key certificate from the platform provider.

On initial startup in the PC space, the TKM may have cached a set of generic validated images to display on the customizable keys of the keyboard. The TKM may then periodically consults with a cloud service of the platform provider to obtain a list of additional keys to display. The cloud service of the platform provider may also be configured to return a list of pre-determined images obtained from a third-party cloud servicer associated with authorized partner. The list may then be delivered back to the TKM, which validates each image as described above.

On startup or during execution of an application belonging to an authorized partner, the application can consult with its own service provider to obtain a signed image structure for a customized key. As described above, the key image may be a specific customized key mapped to a service from a third-party service provider or to an application, as shown in FIG. 1(A), an user-specific opportunities key mapped to dynamic content from a third-party service provider or an application as shown in FIG. 1(B), or a key leased or sold as real-estate on the keyboard by a third-party service provider, as shown in FIG. 1(C). The application may register with the previously mentioned Keyboard Manager running in the operating system or at the application layer and deliver the signed key image to the TKM, which may validate each image. An updated signed key image can be delivered to the TKM periodically, as user content updates may be received by the application from its cloud service.

For each image received, either from a service provider or from an interactive application, the TKM can choose the location of the image on the virtual keyboard. The TKM may first determine if the image is new or a replacement based on the assigned ID number 304. If the image is a replacement image, the image may be displayed on an existing assigned key. If the image is new image, the TKM may prioritize the image among other requested images and assign a new key.

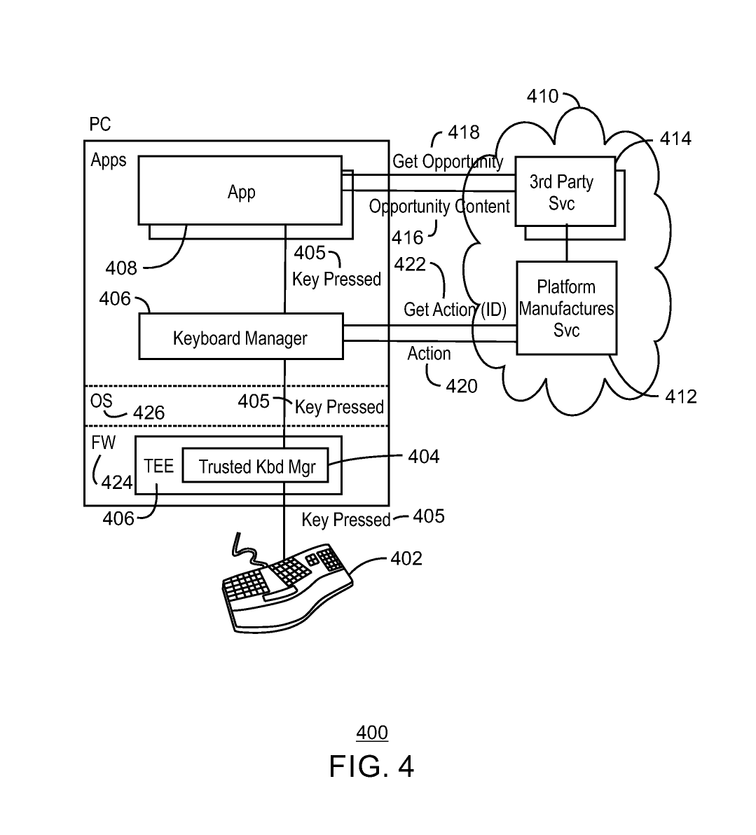

FIG. 4 is a block diagram 400 of architecture for managing the action when a user selects a customized key. If an end-user selects one of the customizable keys on a keyboard 402, a TKM 404 may intercept the pressed key 405 and inform a Keyboard Manager 406 of the identification of that particular key. In operation, the Keyboard Manager 406 may then inform a registered application 408 about the key press event. The application 408 may consult with cloud services 410 such as a platform manufacturer cloud service 412 or a third party cloud service 414. The application 408, during its execution, may then fetch and display opportunity content 416 associated with a opportunity or service 418. For keys delivered directly by a platform provider, and not an application, the Keyboard Manager 406 may consult the platform service 412 provided by a device manufacture to determine an appropriate action 420. In some embodiments, the resulting action 422 can include the launch of a web page. In embodiments, the TKM 404 and a Trusted Execution Environment (TEE) platform 406 are a portion of firmware 424. An operating system 426 may manage the system hardware and software resources, including the keyboard 402.

It is to be understood that the block diagram 400 of FIG. 4 is not intended to indicate that the architecture is to include all of the components shown in FIG. 4 in every case. Further, any number of additional components can be included within the block diagram 400, depending on the details of the specific implementation.

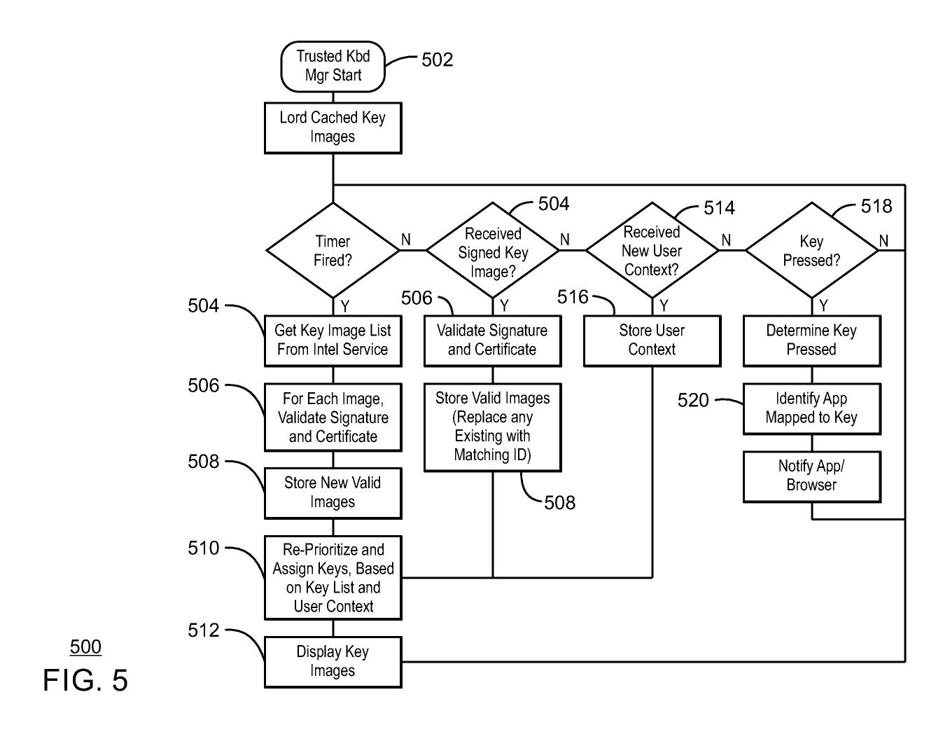

FIG. 5 is a flow diagram 500 of an activity flow of a Trusted Keyboard Manager (TKM) 502. In operation, the TKM 502 may receive a list of images to display 504. As previously discussed, the TKM 502 may validate each image 506, store new images 508, re-prioritize images 510, and display images 512. When individual images are received from applications 514, the TKM 502 may validate the individual image, store the image 516 by overwriting existing images with the same identification, prioritize, and display all images 512. Moreover, after the key is pressed 518, the TKM 502 may work together with a Keyboard Manager to identify the appropriate application 520 and launch the appropriate content.

It is to be understood that the flow diagram 500 of FIG. 5 is not intended to indicate that the activity flow of the TKM is to include all of the components shown in FIG. 5 in every case. Further, any number of additional components can be included within the flow diagram 500, depending on the details of the specific implementation.

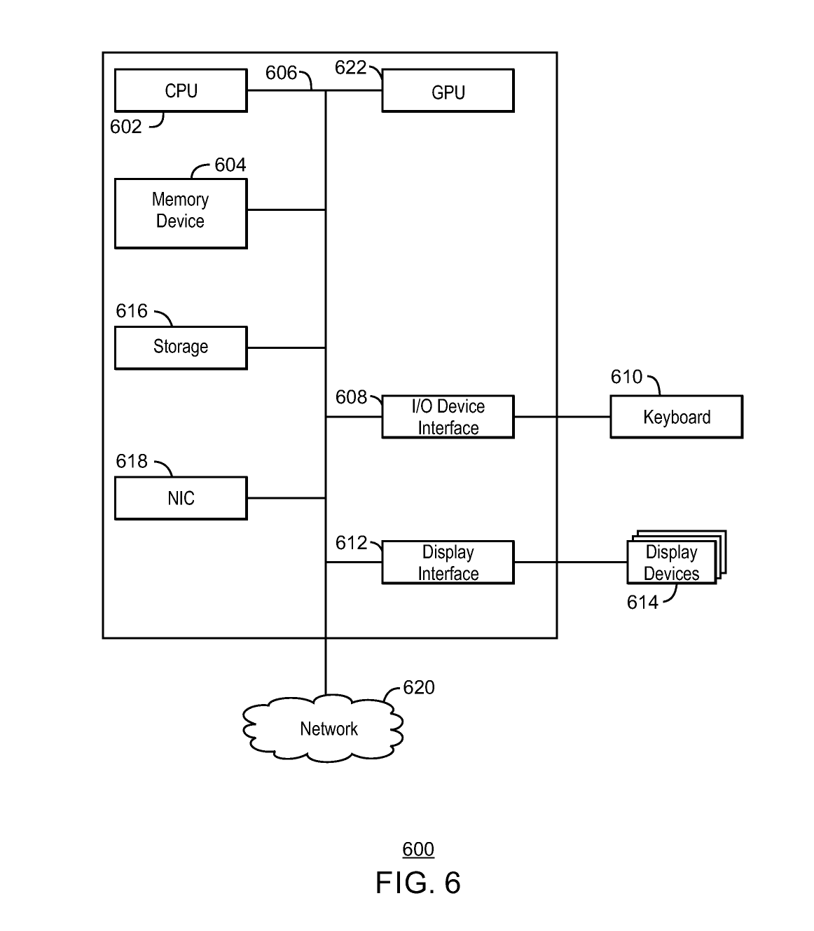

FIG. 6 is a block diagram 600 of a computing device that utilizes a keyboard with dynamically customized keys. The computing device 600 may be, for example, a laptop computer, desktop computer, tablet computer, or mobile device, among others. The computing device 600 may include a central processing unit (CPU) 602 that is configured to execute stored instructions, as well as a memory device 604 that stores instructions that are executable by the CPU 602. The instructions that are executed by the CPU 602 may be used to validate a customized key, deliver a customized key upon a key press, or display the customized key on a keyboard.

The CPU 602 can be a single core processor, a multi-core processor, a computing cluster, or any number of other configurations. The memory device 604 can include random access memory (RAM), read only memory (ROM), dynamic random access memory (DRAM), flash memory, or any other suitable memory systems. The CPU may be coupled to the memory device 604 by a bus 606.

The CPU 602 may be connected through the bus 606 to an I/O device interface 608 configured to connect the computing device 600 to a keyboard 610. The keyboard 610 may include, for example, the keyboard 100 as described with respect to FIGS. 1A, 1B, 1C, which include a specific customized key, a user-specific opportunities key, and a key leased or sold as real-estate. In some embodiments, the I/O devices may include a mouse or a pointing device, wherein the pointing device may include a touchpad or a touchscreen, among others.

The CPU 602 may be linked through the bus 606 to a display interface 612 configured to connect the computing device 600 to one or more display devices 614. The display devices 614 may include a display screen that is a built-in component or that is externally connected to the computing device 600, for example, a computer monitor, television, or projector, among others.

The computing device 600 may include a storage device 616 connected to the CPU 602 via the bus 606. The storage device 616 is a physical memory such as a hard drive, an optical drive, a thumb drive, an array of drives, or any combinations thereof. The storage device 616 may also include remote storage drives. Moreover, the computing device 600 may include a network interface controller (NIC) 618 configured to connect the device 600 through the bus 606 to a network 620. The network 620 may be a wide area network (WAN), local area network (LAN), or the Internet, among other network configurations. In embodiments, the network 620 may include routers, switches, modems, or any other kind of interface devices used for interconnection.

Additionally, the CPU 602 may be connected through the bus 606 to a graphics processing unit (GPU) 622. In some embodiments, the GPU 622 may be embedded in the CPU 602. The GPU 622 may include a cache, and can be configured to perform any number of graphics operations within the computing device 600. For example, the GPU 622 be configured to render or manipulate graphics images, graphics frames, videos, or the like, to be displayed to a user of the computing device 600.

The block diagram of FIG. 6 is not intended to indicate that the computing device 600 is to include all of the components shown in FIG. 6. Further, the computing device 600 may include any number of additional components not shown in FIG. 6, depending on the details of the specific implementation.

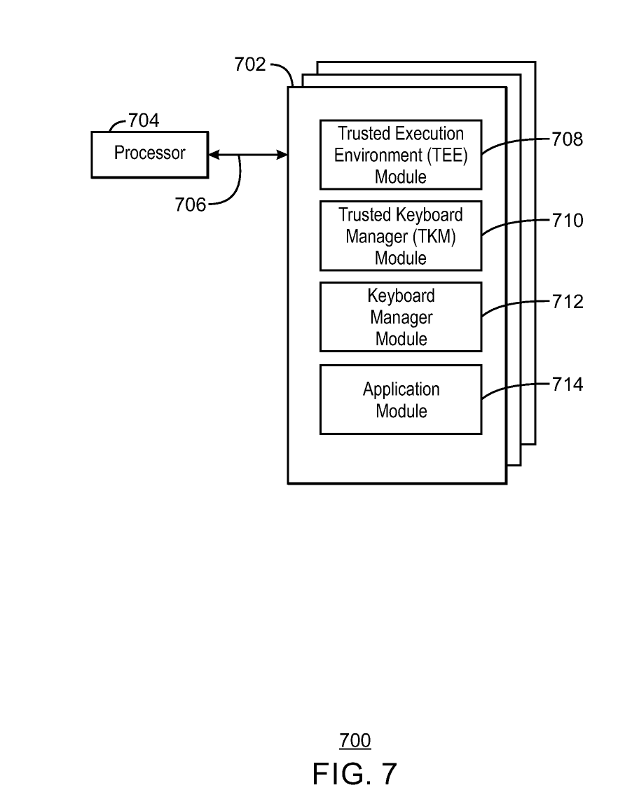

FIG. 7 is a block diagram 700 of a tangible, non-transitory computer-readable medium 702. The tangible, non-transitory computer-readable media 702 may be accessed by a processor 704 over a computer bus 706. Further, the tangible, non-transitory computer-readable medium 702 may include code configured to direct the processor 704 to perform the method described herein.

Various software components may be stored on the tangible, non-transitory computer-readable medium 702, as shown in FIG. 7. For example, at block 708, a trusted execution environment (TEE) module may be configured with hardware features such as a manageability engine (ME) or a secure enclaves (SE) running on a particular computing platform. At block 710, a trusted keyboard manager (TKM) module may be configured to run in the TEE module. The TKM module may be responsible displaying customized keys on a keyboard, delivering key presses of a requested customized key to a keyboard manager, and validating the requested customized key. At block 712, the keyboard manager may be configured to relay information related to the requested customized key. At block 714, an application, which may be informed of the request by the keyboard manager, may be configured to retrieve and display the requested customized key on a portion of a keyboard reserved for such purposes.

The block diagram of FIG. 7 is not intended to indicate that the tangible, non-transitory computer-readable medium 702 is to include all of the components shown in FIG. 7. Further, the block diagram 700 may include any number of additional components not shown in FIG. 7, depending on the details of the specific implementation.

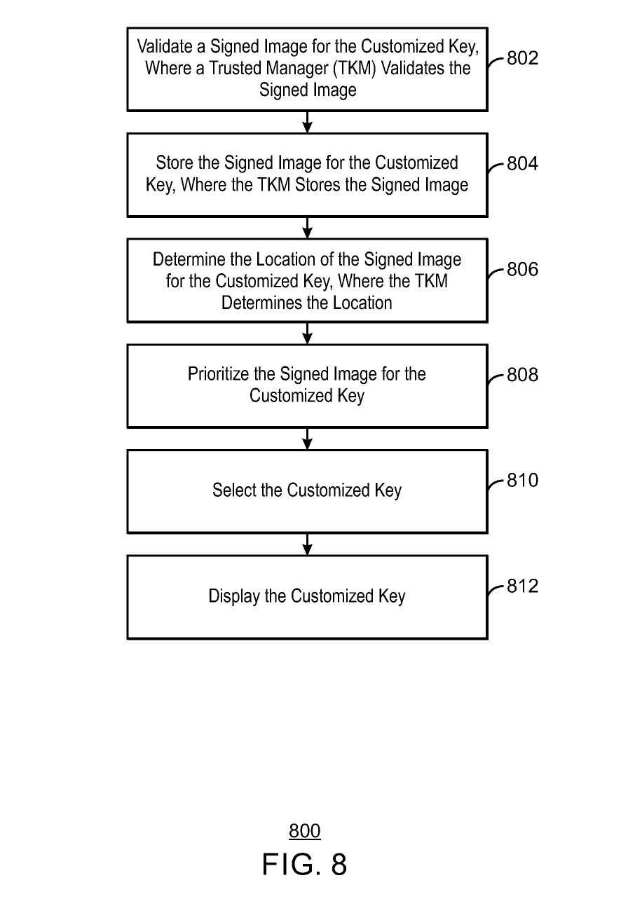

FIG. 8 is a process flow diagram 800 of a method for displaying a signed image for a customized key. At block 802, the signed image for the customized key may be validated by a trusted keyboard manager (TKM). Upon delivering the signed image to the TKM, at block 804, the signed image for the customized key may be stored by the TKM in storage. At block 806, the location in storage for the signed image for the customized key may be determined by the TKM. In determining the location for the signed image, the TKM may determine if the signed image is a new or replacement signed image.

At block 808, the signed image for the customized key may be prioritized, if the signed image is a new image. If the signed image for the customized key is a replacement, the replacement signed image may be displayed on an assigned key. At block 810, the customized key may be selected by a user. Thereafter, at block 812, the customized key may be displayed based on the selection of the user. As a result, the TKM may work with the keyboard manager to identify, register, and launch the content of an application. In some embodiments, the application may be consulted to obtain the signed image for the customized key.

### EXAMPLE 1

An electronic device is described herein. The electronic device includes a keyboard and several customized keys arranged on the keyboard. The keys can include dynamically customized keys based on usage. The customized keys can be mapped to a service of a third-party provider, to user-installed applications, and to live content data. The customized keys can be sold or leased as real-estate on the keyboard. The customized keys can display static content, customer-specific content, third-party content, social-media content, online provider content, online merchant content, and live content. The customized keys can be verified before display on the keyboard. The keyboard includes a virtual keyboard or a physical keyboard. The physical keyboard includes an integrated display that allows a symbol on the customized key to be mapped dynamically to a corresponding function associated with the symbol. The virtual keyboard can be mapped to a specific service, a customer-specific opportunity, or live content.

### EXAMPLE 2

A non-transitory, computer readable medium is described herein. The non-transitory, computer readable medium can be for the display of a customized key and can include code to direct a processor to implement instructions. The instructions may include implementing a trusted execution environment (TEE) module, executing a trusted keyboard manager (TKM) module in the TEE module, implementing a keyboard manager module, and executing an application module.

The TKM of the non-transitory, computer readable medium may be responsible for displaying the customized key on a keyboard space, for delivering a key press of the customized key to the keyboard manager, and for validating that a key image of the customized key is authorized. The TKM may interface with a physical keyboard device. The TKM may overlap the customized key on top of a virtual keyboard to intercept a touch event that corresponds with the customized key. The TKM may collect a set of generic images to display on the customized key and may contact a cloud service to obtain a list of additional customized keys to display. The application of the non-transitory, computer readable medium may consult with a service provider to obtain a signed image of the customized key. The TEE of the non-transitory, computer readable medium may include a manageability engine (ME) or a secure enclaves (SE) on a computing platform. The keyboard manager of the non-transitory, computer readable medium may operate in an operating system or at an application layer to deliver a signed image of the customized key.

### EXAMPLE 3

A signed image is described herein. The signed image may include an image, an assigned private key, a signature generated by the assigned private key, and a public key certificate chain. An authorized owner may generate the image to be displayed. The authorized owner may obtain a unique identifier, a public/private key pair, and a public key certificate chain. The image can be validated before it is displayed. A root of the public key certificate chain may verify the image to be displayed. A trusted keyboard manager (TKM) may verify the signed image and that the signature was generated by the authorized owner.

### EXAMPLE 4

A method of displaying a signed image for a customized key is described herein. The method may include validating the signed image for the customized key, where a trusted keyboard manager (TKM) validates the signed image. The method may include storing the signed image for the customized key, where the TKM stores the signed image. The method may include determining the location of the signed image for the customized key, where the TKM determines the location. The method may include prioritizing the signed image for the customized key, pressing the customized key, and displaying the customized key.

The method may include consulting an application to obtain the signed image for the customized key and registering the application with a keyboard manager. The method may include delivering the signed image for the customized key to the TKM. The method may include delivering an undated signed image for the customized key to the TKM on a periodic basis. The determination of the location may include determining if the signed image is a new signed image or is a replacement signed image. The method may include prioritizing a new signed image and displaying a replacement signed image on an assigned key. The method may include supplying user context information with the consent of the user via a keyboard manager and intercepting the pressing and informing a keyboard manager of the pressed customized key. The method may include informing the application of the pressing.

### EXAMPLE 5

A method is described herein. The method includes a means for validating the signed image for the customized key, where a trusted keyboard manager (TKM) validates the signed image. The method includes a means for storing the signed image for the customized key, where the TKM stores the signed image. The method includes a means for determining the location of the signed image for the customized key, where the TKM determines the location. The method includes a means for prioritizing the signed image for the customized key, a means for selecting the customized key, and a means for displaying the signed image for the customized key.

The method includes a means for consulting an application to obtain the signed image for the customized key and a means for registering the application with a keyboard manager. The method includes a means for delivering the signed image for the customized key to the TKM and a means for delivering an undated signed image for the customized key to the TKM on a periodic basis. The determining of the location of the signed image for the customized key includes determining if is a new signed image or is a replacement signed image. The method includes a means for prioritizing a new signed image and a means for displaying a replacement signed image on an assigned key. The method includes a means for supplying user context information with the consent of the user via a keyboard manager and a means for intercepting the selection and informing a keyboard manager of the selected customized key. The method includes a means for informing the application of the pressing.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may,” “might,” “can,” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An electronic device, comprising:
a keyboard;
a plurality of keys arranged on the keyboard, wherein the plurality of keys comprise dynamically customized keys based on usage.

2. The electronic device of claim 1, wherein the customized keys are sold or leased as real-estate on the keyboard.

3. The electronic device of claim 1, wherein the customized keys display static content, customer-specific content, third-party content, social-media content, online provider content, online merchant content, and live content.

4. The electronic device of claim 1, wherein the customized keys are verified before display on the keyboard.

5. The electronic device of claim 1, wherein the keyboard includes a virtual keyboard or a physical keyboard.

6. A non-transitory, computer readable medium for the display of a customized key comprising code to direct a processor to:
implement a trusted execution environment (TEE) module;
execute a trusted keyboard manager (TKM) module in the TEE module;
implement a keyboard manager module; and
execute an application module.

7. The computer-readable medium of claim 6, wherein the TKM module is responsible for displaying the customized key on a keyboard space.

8. The computer-readable medium of claim 6, wherein the TKM is responsible for validating that a key image of the customized key is authorized.

9. The computer-readable medium of claim 6, wherein the application consults with a service provider to obtain a signed image of the customized key.

10. The computer-readable medium of claim 6, wherein the TEE comprises a manageability engine (ME) or a secure enclaves (SE) on a computing platform.

11. The computer-readable medium of claim 6, wherein the keyboard manager operates in an operating system or at an application layer to deliver a signed image of the customized key.

12. A signed image to be rendered on a customized key, comprising
an electronic image;
an assigned private key;
a signature generated using the assigned private key; and
a public key certificate chain.

13. The signed image to be rendered on a customized key of claim 12, wherein an authorized owner generates the image.

14. The signed image to be rendered on a customized key of claim 12, wherein the authorized owner obtains a unique identifier, a public/private key pair, and a public key certificate chain.

15. The signed image to be rendered on a customized key of claim 12, wherein a trusted keyboard manager (TKM) verifies the signed image.

16. The signed image to be rendered on a customized key of claim 15, wherein the TKM verifies the signature was generated by the authorized owner.

17. A method of displaying a signed image for a customized key, comprising:
validating the signed image for the customized key, wherein a trusted keyboard manager (TKM) validates the signed image;
storing the signed image for the customized key, wherein the TKM stores the signed image;
determining the location of the signed image for the customized key, wherein the TKM determines the location;
prioritizing the signed image for the customized key;
selecting the customized key; and
displaying the customized key.

18. The method of claim 17, comprising consulting an application to obtain the signed image for the customized key.

19. The method of claim 17, comprising registering the application with a keyboard manager.

20. The method of claim 17, comprising delivering the signed image for the customized key to the TKM.

21. The method of claim 17, comprising delivering an undated signed image for the customized key to the TKM on a periodic basis.

22. The method of claim 17, wherein the determining the location of the signed image for the customized key comprises determining if the signed image is a new signed image or is a replacement signed image.

23. The method of claim 17, comprising supplying user context information with the consent of the user via a keyboard manager.

24. The method of claim 17, comprising intercepting the selecting and informing a keyboard manager of the selected customized key.

25. The method of claim 17, comprising informing the application of the selecting of the customized key.
